(19) United States
(12) Patent Application Publication
(10) Pub. No.: US 2022/0092048 A1
(43) Pub. Date: Mar. 24, 2022

(54) Techniques and Architectures for Providing an Extract-Once Framework Across Multiple Data Sources

(71) Applicant: Salesforce.com, inc., San Francisco, CA (US)

(72) Inventors: Zhidong Ke, Milpitas, CA (US); Yifeng Liu, Palo Alto, CA (US); Heng Zhang, San Jose, CA (US); Utsavi Benani, Fremont, CA (US); Kevin Terusaki, Oakland, CA (US); Priyadarshini Mitra, San Francisco, CA (US)

(21) Appl. No.: 17/026,061

(22) Filed: Sep. 18, 2020

(51) Int. Cl. G06F 16/22; G06F 16/28; G06F 16/2457; G06F 16/23; G06F 16/27

(52) U.S. Cl. CPC G06F 16/2282; G06F 16/283; G06F 16/2358; G06F 16/2308; G06F 16/278; G06F 16/24573

(57) ABSTRACT

Architectures and techniques to provide an extract-once framework for data ingestion into a data lake. A data consumption job to ingest data to multiple tables within a data collection platform is started. Checkpoint metadata corresponding to the data consumption job is retrieved from a checkpoint metadata store. A subset of processes from the data consumption job are performed. Checkpoint metadata is updated in response to completion of the subset of processes. A subsequent subset of processes from the data consumption job is performed. Checkpoint metadata is updated in response to completion of each of the at least one subsequent subset of processes from the data consumption job. Batch metadata is updated in response to completion of the data consumption job.

### TECHNICAL FIELD

Embodiments relate to techniques for managing data traffic in environments not providing native atomic transactions to provide, for example, ingestion of data without duplication. More particularly, embodiments relate to techniques for managing data traffic in environments not providing native atomic transactions by, for example, utilizing checkpointing and micro-batches to manage ingestion of data to reduce or eliminate duplicate ingestion operations.

### BACKGROUND

A “data lake” is a collection data from multiple sources and is not stored in a standardized format. Because of this, collection of the data in the data lake is not as systematic and predictable as more structured collections of data. Thus, many of the tools that are utilized to ingest data into a data lake (or other data collection structures) do not (or cannot) provide atomic writes to the final data source.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an architecture to provide an extract-once framework in a data lake environment.

FIG. 2 is a block diagram of an architecture to provide an extract-once framework servicing multiple data sources.

FIG. 3 is a flow diagram of an example embodiment of a technique to provide an extract-once framework servicing multiple data sources.

FIG. 4 is a block diagram of one embodiment of a processing resource and a machine readable medium encoded with example instructions to provide an extract-once framework servicing multiple data sources.

FIG. 5 is a block diagram of an example environment in which incremental an extract-once framework in a data lake environment can be provided.

FIG. 6 illustrates a block diagram of an environment where an on-demand database service might be used.

FIG. 7 illustrates a block diagram of an environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

In general, a data lake is a data repository that stores data in its native format until the data is needed. Typically, these data repositories are very large and ingest constant (or near constant) data streams for multiple sources. The term “data lake” refers to the strategy of gathering large amounts of natively-formatted data and not to any particular mechanisms for maintaining the repository. Thus, the mechanisms described herein are described as certain embodiments with respect to various components and data flow elements; however, the techniques are more broadly applicable and could be used with other components or in other environments.

Some data lake implementations are based on Apache Hadoop, which provides various software utilities that provide distributed processing of large data sets across multiple computing devices. Other data lake implementations can be based on Apache Spark, which provides a framework for real time data analytics using distributed computing resources. Other platforms and mechanisms can be utilized to manage data lakes (or other large collections of data).

In the description that follows a shared activity store (SAS) can function as a data lake to collect raw data from any number of disparate data sources to be utilized by any number of data consumers. As the environment that the SAS serves grows the volume of data to be ingested and managed grows, so an efficient scalable mechanism for managing the SAS data is highly desirable. In some embodiments when there is any insertion, update or deletion to data in the SAS incremental change information can be provided to one or more downstream data consumers. Various techniques and mechanisms for accomplishing this goal are described below. In embodiments within a multitenant environment, the SAS can support a query for updates per organization.

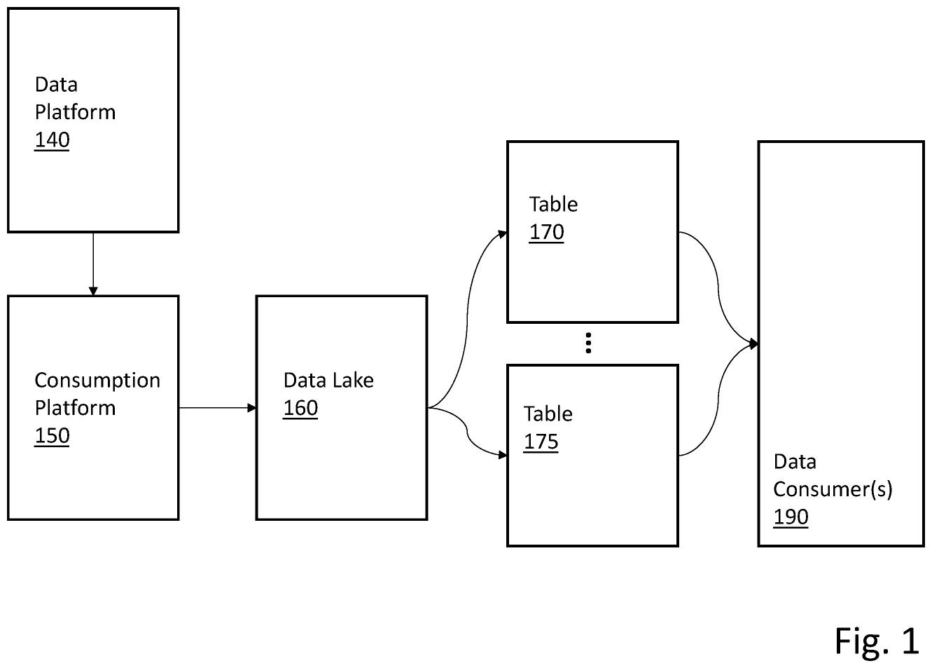

FIG. 1 is a block diagram of one embodiment of an architecture to provide extract-once framework in a data lake environment. The block diagram of FIG. 1 provides a data management mechanism that can be utilized to manage data in a data lake (or other collection of data). One example of a data lake is the SAS discussed above. The mechanism of FIG. 1 provides the ability to manage and provide access to modifications of data in a data lake or similar data repository.

Data platform 140 can provide a structure for handling large data loads. For example, in some embodiments, data platform 140 can be provided utilizing Apache Kafka (or similar architecture). Apache Kafka is an open source platform available from Apache Software Foundation based in Wakefield, Mass., USA. Other stream processing and/or message broker platforms can be utilized in different embodiments.

Continuing with the Kafka example, Kafka provides a unified, high-throughput, low-latency platform for handling real-time data feeds. Kafka is based on a commit long concept and allows data consumers to subscribe to data feeds to be utilized by the consumer, and can support real-time applications. In operation, Kafka stores key-value messages from any number of producers, and the data can be partitioned into topic partitions that are independently ordered. Consumers can read messages from subscribed topics.

Data platform 140 functions to gather various types of raw data from any number of data sources (not illustrated in FIG. 1). These data sources can include, for example, data received via graphical user interfaces (GUIs), location data (e.g., global positioning system (GPS) data), sensor data, retrieved data, etc. Any type of data from any number of disparate data sources can provide data to be gathered via data platform 140.

Consumption platform 150 can provide a mechanism to consume data from data platform 140 and manage ingestion of the data to data lake 160. In some embodiments, consumption platform 150 is a distributed cluster-computing framework that can provide data parallelism and fault tolerance. For example, in some embodiments, consumption platform 150 can be provided utilizing Apache Spark (or similar architecture). Apache Spark is an open source platform available from Apache Software Foundation based in Wakefield, Mass., USA. Other consumption platforms and/or data management mechanisms can be utilized in different embodiments.

Continuing with the Spark example, Spark provides an open source distributed general purpose cluster computing framework with an interface for programming clusters with parallelism and fault tolerance. Spark can be used for streaming of data from data platform 140 to data lake 160. Thus, in various embodiments, large numbers of parallel Spark jobs can be utilized to ingest data to data lake 160.

Data lake 160 functions to store data acquired via data platform 140 and managed/routed by consumption platform 150. In various embodiments, data ingestion can be provided by parallel streaming jobs (e.g., Spark streaming jobs) that can function to consume data in real time (or near real time).

In one embodiment, one of the streaming jobs writes a file to table 170 with changes to data in data lake 160. In various embodiments, the files written to table 170 can include multiple records. For example, multiple incremental changes to a partition (or other organizational structure) can be collected as records (or objects) and the records (or objects) corresponding to changes during the current interval can be collected and written to table 170 as a single file. In some embodiments, file can be split if the file size would exceed a pre-selected threshold. Thus, multiple files may be written for a single time interval.

In one embodiment, another streaming job writes a file to table 175. In some embodiments, the files written to table 175 can include information related to a corresponding file written to table 170. In these embodiments, the file(s) written to table 175 include at least identification information for the files in table 170 corresponding to changes over the pre-selected interval. Data consumer(s) 190 can then utilize information from tables 170 and 175. Any number of tables can be supported in this architecture.

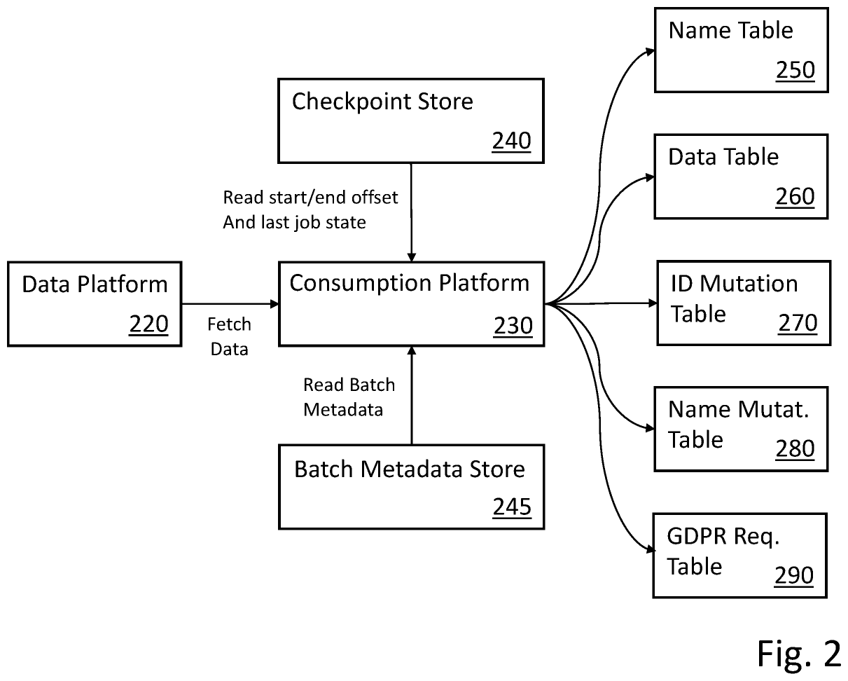

FIG. 2 is a block diagram of an architecture to provide an extract-once framework servicing multiple data sources. The block diagram of FIG. 2 provides an ingestion mechanism that can be utilized to provide data to a data lake (or other collection of data). That is, one or more of the components of FIG. 2 can be included in the architecture of FIG. 1.

Data platform 220 (similar to data platform 140) can provide a structure for handling large data loads. For example, in some embodiments, data platform 220 can be provided utilizing Apache Kafka (or similar architecture). Other stream processing and/or message broker platforms can be utilized in different embodiments.

Data platform 220 functions to gather various types of raw data from any number of data sources (not illustrated in FIG. 2). These data sources can include, for example, data received via graphical user interfaces (GUIs), location data (e.g., global positioning system (GPS) data), biometric data, etc. Any type of data from any number of disparate data sources can provide data to be gathered via data platform 220.

Consumption platform 230 (similar to consumption platform 150) can provide a mechanism to consume data from data platform 220 and manage ingestion of the data to the data lake. In some embodiments, consumption platform 230 is a distributed cluster-computing framework that can provide data parallelism and fault tolerance. For example, in some embodiments, consumption platform 230 can be provided utilizing Apache Spark (or similar architecture). Other consumption platforms and/or data management mechanisms can be utilized in different embodiments. Spark can be used for streaming of data from data platform 220 to the data lake. Thus, in various embodiments, large numbers of parallel Spark jobs can be utilized to ingest data to the data lake.

The data lake functions to store data acquired via data platform 220 and managed/routed by consumption platform 230. In various embodiments, data ingestion can be provided by parallel streaming jobs (e.g., Spark streaming jobs) that can function to consume data in real time (or near real time) and write the data to any number of data tables (e.g., name table 250, data table 260, ID mutation table 270, name mutation table 280, GDPR request table 290). Any number of similar parallel structures can be supported.

As described in greater detail below, consumption platform 230 can utilize checkpoint store 240 and batch metadata store 245 to provide extract-once functionality while servicing multiple data sources. Utilizing the architectures and techniques described herein, in various embodiments, when a job tries to process and write data to multiple data tables, that data is processed and written exactly once. In various embodiments, if data is process and written to one or more tables successfully, but the job fails before writing to all tables, a replay mechanism is provided that skips the successful writes.

In some embodiments, consumption platform jobs are executed as micro-batches and each micro-batch includes multiple processes (e.g., process and write data to name table 250, process and write data to data table 260, etc.). In these embodiments, the batch state may be maintained.

In the example embodiment of FIG. 2, batch metadata store 245 can be utilized to store batch state information, for example, job name, batch ID (e.g., the last successful batch ID provided by a job), user defined process name, time stamp of last successful modification, etc. In one embodiment, the structure of the batch metadata store entries is: job_id, batch_id, process_name, last_modified. Other and/or different metadata can also be maintained utilizing batch metadata store 245.

In some embodiments, after reading from checkpoint store 240, consumption platform 230 can determine the last job state. If the last batch completed successfully, consumption platform 230 can increase the last batch ID, otherwise consumption platform 230 can maintain the last batch ID. In one embodiment, the structure of checkpoint store entries is: Kafka_partition_id, offset, Kafka_broker_host. In some embodiments, consumption platform 230 can fetch batch metadata from batch metadata store 245 based on job name. In alternate embodiments, other identifiers can be utilized.

If all processes in a job succeed, consumption platform 230 can read data from data platform 220 based on a start offset maintained in checkpoint store 240. Otherwise, consumption platform 230 can read an amount of data based on the start offset and an end offset maintained in checkpoint store 240, and the processes with matching batch IDs can be skipped so that the remaining processes are re-processed to avoid duplicate processing.

In the example embodiment of FIG. 2, after completion of all processes (e.g., write to name table 250, write to data table 260, write to ID mutation table 270, etc.), consumption platform 230 can update checkpoint store 240 with an offset and job state information including the corresponding batch ID.

Thus, the process described can guarantee that data is processed and written exactly once while servicing multiple data sources and writing to multiple destinations and successful processes can be skipped when retrying in order to provide a more efficient performance and resource utilization.

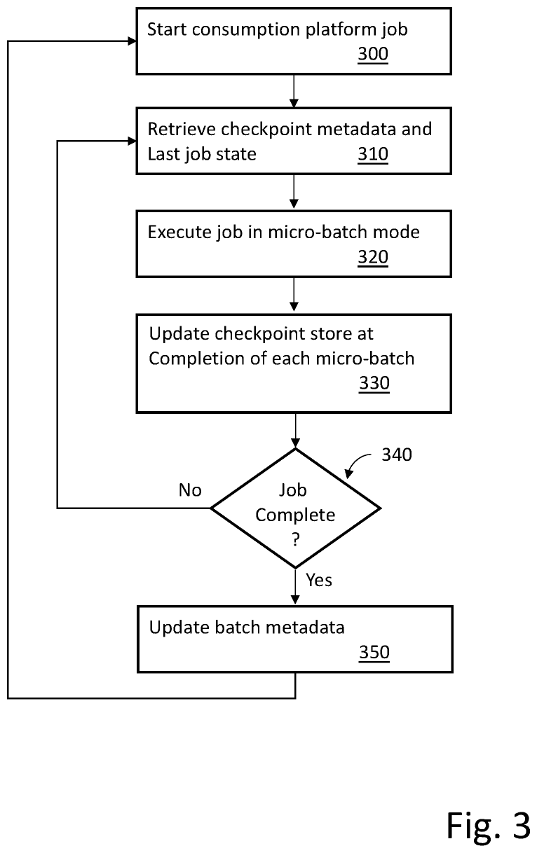

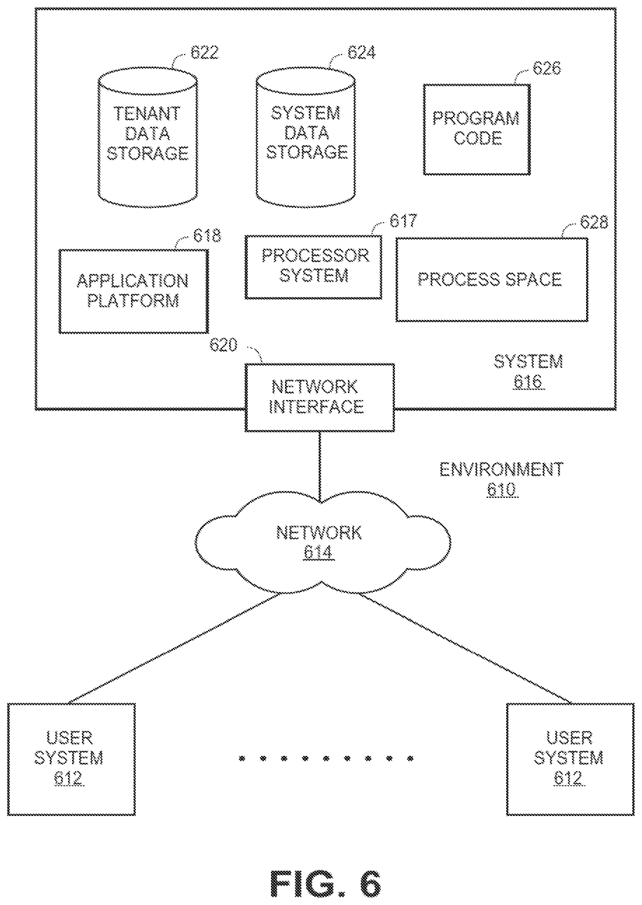

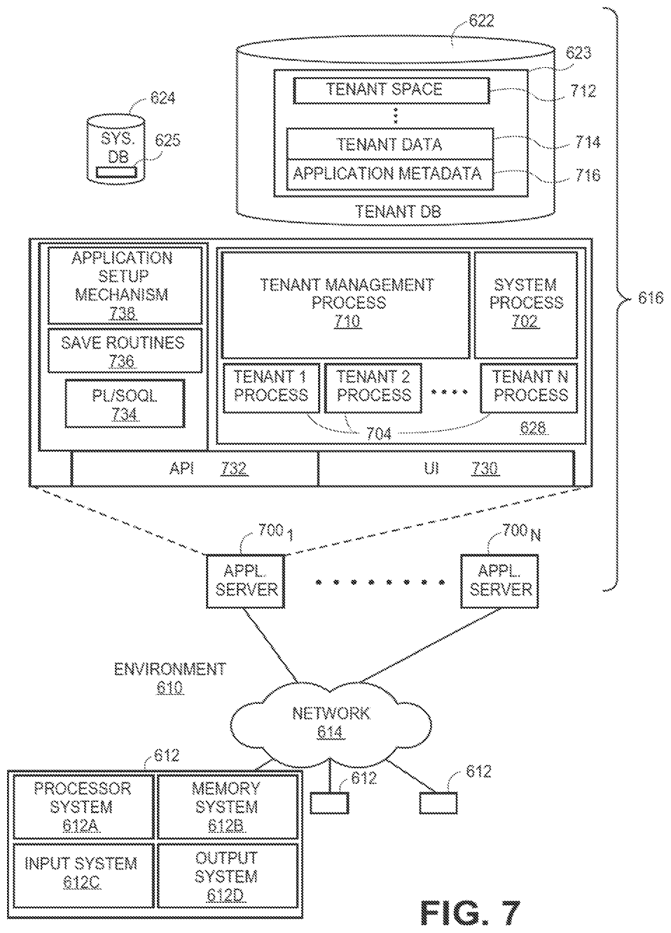

FIG. 3 is a flow diagram of an example embodiment of a technique to provide an extract-once framework servicing multiple data sources. The technique of FIG. 3 can be provided within, for example, the architectures of FIGS. 1, 2 and 5 (as well as within on-demand service environments like the examples of FIGS. 6 and 7).

The example of FIG. 3 is provided in terms of a single consumption platform job; however, any number of parallel jobs can be managed within the consumption platform. A consumption platform job is started, 300. As discussed above, the consumption platform can be a Spark-based platform and the jobs can be corresponding Spark jobs.

The consumption platform can retrieve checkpoint metadata from the metadata store and last job state information from the batch metadata store, 310. This information can allow the consumption platform to determine which processes within the job have been completed successfully so that processes are not repeated, which supports the concept of an extract-once framework.

The consumption platform job is executed in micro-batches, 320. That is, each job includes multiple processes (e.g., write to a name table, write to a data table, write to a data mutation table, write to a name mutation table, write to a GDPR request table, etc.). Micro-batches include a subset of processes for the full job. Conceptually, the job is performed in chunks.

After successful completion of each micro-batch, the checkpoint store can be updated, 330. If the full job is not complete, 340, at the completion of a micro-batch (with corresponding updates), checkpoint metadata and last job state information can be retrieved, 310. The subsequent micro-batch can be executed, 320, and the checkpoint store can be updated upon completion of the subsequent micro-batch, 330.

If the full job is complete, 340, at the completion of the micro-batch, a new consumption platform job can be started, 330. As discussed above, multiple parallel jobs can be supported to write to the same (or overlapping sets) tables within the data lake.

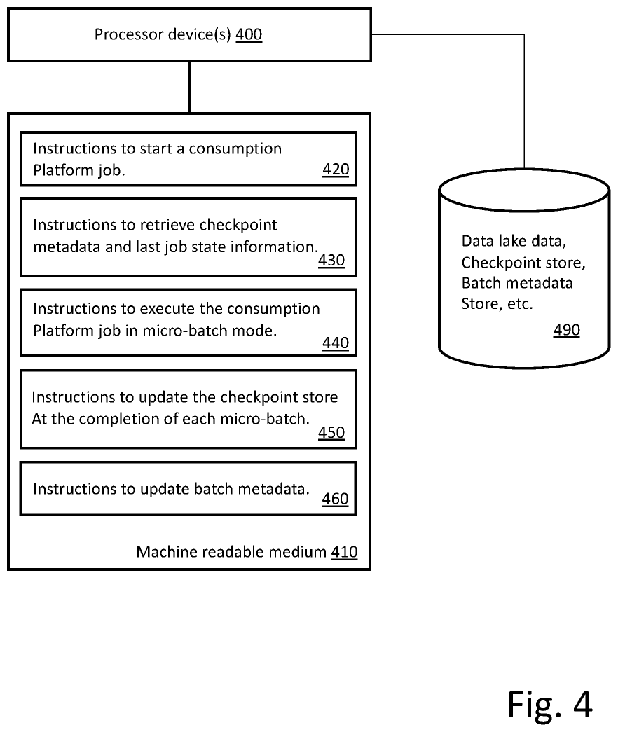

FIG. 4 is a block diagram of one embodiment of a processing resource and a machine readable medium encoded with example instructions to provide an extract-once framework servicing multiple data sources. Machine readable medium 410 is non-transitory and is alternatively referred to as a non-transitory machine readable medium 410. In some examples, the machine readable medium 410 may be accessed by processor device(s) 400. Processor device(s) 400 and machine readable medium 410 may be included in computing nodes within a larger computing architecture.

Machine readable medium 410 may be encoded with example instructions 420, 430, 440, 450 and 460. Instructions 420, 430, 440, 450 and 460, when executed by the processor device(s) 400, may implement various aspects of the techniques for providing an extract-once framework servicing multiple data sources as described herein.

In some embodiments, instructions 420 cause processor device(s) 400 to start a consumption platform job. The consumption platform job can write to the data lake maintained on storage device(s) 590 as well as access the checkpoint store and batch metadata store, which can also be maintained on storage device 590. As discussed above, multiple tables can be maintained and utilized in parallel utilizing parallel jobs in the consumption platform. In some embodiments, at least a portion of the described functionality can be provided in association with open source components (e.g., KAFKA, SPARK). In some embodiments, the described functionality is provided within a multitenant on-demand services environment, example embodiments of which are described below.

In some embodiments, instructions 430 cause processor device(s) 400 to retrieve checkpoint metadata and last job state information. This information can be maintained on storage device(s) 490 and can be maintained utilizing the formats described above. In alternate embodiments, other formats having more and/or different information can be supported.

In some embodiments, instructions 440 cause processor device(s) 400 to execute the consumption job in micro-batch mode. Thus, instructions 440 can execute a portion of the consumption platform job by, for example, writing to one or more tables on storage device(s) 490. In some embodiments, a micro-batch can consist of processing data and writing to a single table on storage device 490. In other embodiments, a micro-batch can consist of processing data and writing to multiple (e.g., 2, 3, 4, 5) tables, but a subset of the larger consumption platform job.

In some embodiments, instructions 450 cause processor device(s) 400 to update the checkpoint store maintained on storage device 490 in response to completion of each micro-batch. In some embodiments, instructions 460 cause processor device(s) 400 to update batch metadata stored on storage device 490 in response to completion of the consumption platform job.

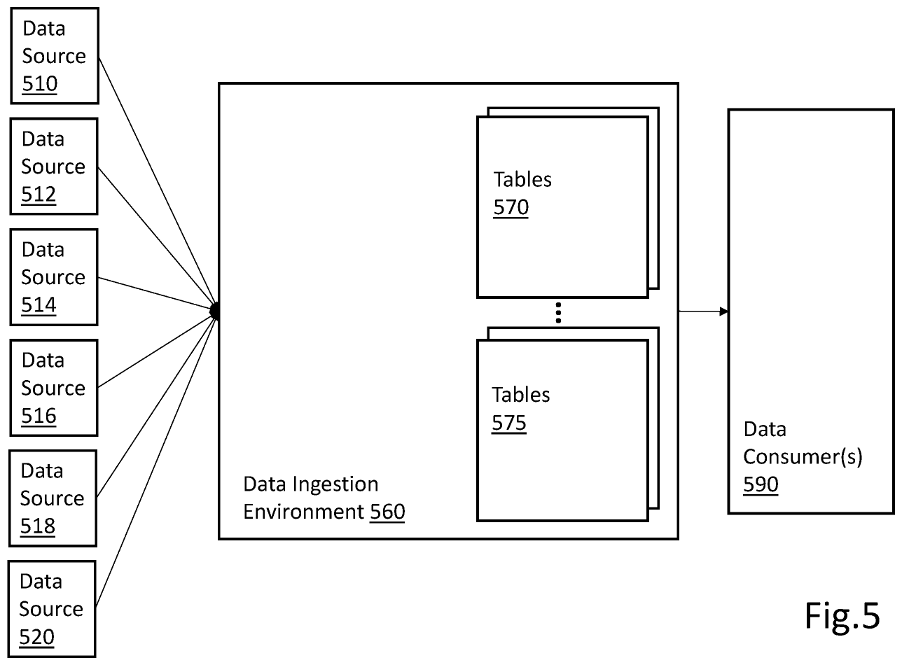

FIG. 5 is a block diagram of an example environment in which incremental an extract-once framework in a data lake environment can be provided. The architecture of FIG. 5 provides a mechanism for gathering data from various sources and handling the ingestion of the data in the manner described above. Various use cases are provided herein; however, the architectures and mechanisms may be more broadly applicable than these use cases.

Any number of data sources (e.g., 510, 512, 514, 516, 518, 520) can be communicatively coupled with data ingestion environment 560 to provide various types of data. As discussed above, data ingestion environment 560 can be part of (or communicatively coupled with) a data lake that can absorb many types of raw data. The data can be, for example, user input from a graphical user interface (GUI), device movements (e.g., mouse, trackpad, eye tracking, gestures), browsing history, operating system information, security profiles, or any other type of data.

Data ingestion environment 560 can receive data from the various data sources and can write the data to one or more sets of tables (e.g., 570, 575) as described herein. In some embodiments, for example, data ingestion environment 560 can maintain a data path for user input through a specific GUI (that may be accessed by multiple users on multiple devices), and a data table and a corresponding notification table can be utilized to write the user input as an atomic transaction to be consumed by one or more data consumers 590.

Data consumers 590 can be any type of device/entity that utilizes the data gathered by data ingestion environment 560. A data consumer can be, for example, a customer relationship management (CRM) platform that analyses and manages information and communications corresponding to various sales flows. A data consumer can be, for example, an artificial intelligence (AI) platform that predicts market conditions based on gathered data.

As mentioned above, one or more of the components discussed can be part of a multitenant on-demand services environment. In this example, various domains can be supported within the environment. For example, a sales domain may provide user input related to sales processes and an analytics domain may operate on data gathered from the sales domain and/or data from other domains. Thus, the atomic transactions described herein can be used to support complex data flows between many different types of data sources and many different types of data consumers.

As mentioned above, the data lake can be part of an environment that also includes an on-demand services environment that can include a multitenant database (or other component). Example embodiments are described in FIGS. 6 and 7.

A tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core series processor or the like. Similarly, system 616 (and additional instances of an MTS, where more than one is present) and all of their components might be operator configurable using application(s) including computer code to run using a central processing unit such as processor system 617, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 BIG-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more processors, are configurable to cause the one or more processors to:
start a data consumption job to ingest data from at least one of the disparate heterogenous sources to multiple tables within the data collection platform, the data consumption job having multiple processes for processing and writing data to at least one of the multiple tables;
retrieve checkpoint metadata corresponding to the data consumption job from a checkpoint metadata store;
perform a subset of processes from the data consumption job;
update the checkpoint metadata in the checkpoint metadata store corresponding to the data consumption job in response to completion of the subset of processes from the data consumption job;
perform at least one subsequent subset of processes from the data consumption job;
update the checkpoint metadata in the checkpoint metadata store corresponding to the data consumption job in response to completion of each of the at least one subsequent subset of processes from the data consumption job;
update batch metadata in a batch metadata store in response to completion of the data consumption job.

2. The non-transitory computer-readable medium of claim 1 wherein multiple concurrent data consumption jobs are maintained by the data collection platform.

3. The non-transitory computer-readable medium of claim 1 wherein the checkpoint metadata store maintains at least a partition identifier, an offset value and a host identifier, for multiple data consumption jobs.

4. The non-transitory computer-readable medium of claim 1 wherein the batch metadata store maintains at least a job identifier, a batch identifier, a process name, a time last modified indication, for multiple data consumption jobs.

5. The non-transitory computer-readable medium of claim 1 wherein the multiple tables include at least a name table, a data table, an identifier mutation table, and a name mutation table.

6. The non-transitory computer-readable medium of claim 1 further comprising data from at least one of the multiple data tables to a data consumer that is external to the data collection platform.

7. The non-transitory computer-readable medium of claim 6 wherein the data collection platform comprises a data lake.

8. The non-transitory computer-readable medium of claim 7 wherein the data lake is maintained within an on-demand services environment that provides services to multiple tenants.

9. A method for ingesting data from disparate heterogeneous sources into a data collection platform, the method comprising:
starting a data consumption job to ingest data from at least one of the disparate heterogenous sources to multiple tables within the data collection platform, the data consumption job having multiple processes for processing and writing data to at least one of the multiple tables;
retrieving checkpoint metadata corresponding to the data consumption job from a checkpoint metadata store;
performing a subset of processes from the data consumption job;
updating the checkpoint metadata in the checkpoint metadata store corresponding to the data consumption job in response to completion of the subset of processes from the data consumption job;
performing at least one subsequent subset of processes from the data consumption job;
updating the checkpoint metadata in the checkpoint metadata store corresponding to the data consumption job in response to completion of each of the at least one subsequent subset of processes from the data consumption job;
updating batch metadata in a batch metadata store in response to completion of the data consumption job.

10. The method of claim 9 wherein the checkpoint metadata store maintains at least a partition identifier, an offset value and a host identifier, for multiple data consumption jobs.

11. The method of claim 9 wherein the batch metadata store maintains at least a job identifier, a batch identifier, a process name, a time last modified indication, for multiple data consumption jobs.

12. The method of claim 9 wherein the multiple tables include at least a name table, a data table, an identifier mutation table, and a name mutation table.

13. The method of claim 9 further comprising data from at least one of the multiple data tables to a data consumer that is external to the data collection platform.

14. The method of claim 14 wherein the data collection platform comprises a data lake.

15. A system comprising:
a data storage device;
one or more processors coupled with the data storage device, the one or more processors to start a data consumption job to ingest data from at least one of the disparate heterogenous sources to multiple tables within the data collection platform, the data consumption job having multiple processes for processing and writing data to at least one of the multiple tables, to retrieve checkpoint metadata corresponding to the data consumption job from a checkpoint metadata store, to perform a subset of processes from the data consumption job, to update the checkpoint metadata in the checkpoint metadata store corresponding to the data consumption job in response to completion of the subset of processes from the data consumption job, to perform at least one subsequent subset of processes from the data consumption job, to update the checkpoint metadata in the checkpoint metadata store corresponding to the data consumption job in response to completion of each of the at least one subsequent subset of processes from the data consumption job, and to update batch metadata in a batch metadata store in response to completion of the data consumption job.

16. The system of claim 15 wherein the checkpoint metadata store maintains at least a partition identifier, an offset value and a host identifier, for multiple data consumption jobs.

17. The system of claim 15 wherein the batch metadata store maintains at least a job identifier, a batch identifier, a process name, a time last modified indication, for multiple data consumption jobs.

18. The system of claim 15 wherein the multiple tables include at least a name table, a data table, an identifier mutation table, and a name mutation table.

19. The system of claim 15 further comprising data from at least one of the multiple data tables to a data consumer that is external to the data collection platform.

20. The system of claim 19 wherein the data collection platform comprises a data lake.
